(19) United States
(12) Patent Application Publication
(10) Pub. No.: US 2024/0121293 A1
(43) Pub. Date: Apr. 11, 2024

(54) METHODS AND SYSTEMS FOR IMPLEMENTING A DIGITAL PHOTOGRAPH SHARING MOBILE APPLICATION

(71) Applicant: RAJESHKUMAR K. MEHTA, milipitas, CA (US)

(72) Inventor: RAJESHKUMAR K. MEHTA, milipitas, CA (US)

(21) Appl. No.: 18/212,161

(22) Filed: Jun. 20, 2023

Related U.S. Application Data
(63) Continuation-in-part of application No. 17/373,760, filed on Jul. 12, 2021, now abandoned.
Application No. 17/373,760 is a continuation-in-part of application No. 17/175,605, filed on Feb. 12, 2021, now abandoned.
(60) Provisional application No. 62/975,204, filed on Feb. 12, 2020.

(51) Int. Cl. H04L 67/10

(52) U.S. Cl. CPC H04L 67/10

(57) ABSTRACT

In one aspect, a computerized method utilizing an instant digital photo-sharing mobile application using a cloud-computing platform comprising: creating an event and an event album with a digital photo-sharing mobile application by: allowing a host to create the event, creating the event album for the event; inviting a set of collaborators to the event; obtaining and uploading a set of digital images as the event album to a digital-image aggregator in a cloud-computing platform, wherein the digital images are provided by the host of the event and the set of collaborators at said event; with the digital-image aggregator in the cloud-computing platform, aggregating the set of digital pictures; sharing the set of digital pictures of the event album between a specified event team that the host has designated, wherein the set of digital pictures are accessible via the cloud-computing platform using a website or a mobile-device application used by authenticated members of the specified event team; and providing a digital photo-sharing mobile application that allows a collaborator to remove unwanted pictures from the event album post events; and enabling the host and the set of collaborators to share the set of digital pictures in the event album via a social media application.

### CLAIM OF PRIORITY

This application is a continuation in part of and claims priority to U.S. patent application Ser. No. 17/373,760, filed on Jul. 12, 2021 and titled METHODS AND SYSTEMS FOR IMPLEMENTING A DIGITAL PHOTOGRAPH SHARING MOBILE APPLICATION. This application is hereby incorporated by reference in its entirety.

United States patent application No. is a continuation in part of and claims priority to U.S. patent application Ser. No. 17/175,605, filed on Feb. 12, 2021 and titled METHODS AND SYSTEMS FOR IMPLEMENTING A DIGITAL PHOTOGRAPH SHARING MOBILE APPLICATION. This application is hereby incorporated by reference in its entirety.

U.S. patent application Ser. No. 17/175,605 claims priority to U.S. Provisional Patent Application No. 62/975,204, filed on 12 Feb. 2020, and titled METHODS AND SYSTEMS FOR IMPLEMENTING A DIGITAL PHOTOGRAPH SHARING MOBILE APPLICATION. This application is hereby incorporated by reference in its entirety.

### BACKGROUND

As of today, millions of pictures (e.g. digital images, digital videos, etc.) are taken with smart phones and/or other mobile devices. These are stored on those individual devices. The pictures can record various events, including, inter alia: marriage, birthday parties, school events, reunions, corporate events and many more day to day moments. While, people wish to share the memories via the photos taken in any event (e.g. Birthday parties, family gatherings, office events, kids functions, etc.), in most of the cases, the sharing never occurs due to the extra steps a user would have to take to manually share the pictures via text message. Email, posting to social network, etc.

### SUMMARY OF THE INVENTION

In one aspect, a computerized method utilizing an instant digital photo-sharing mobile application using a cloud-computing platform comprising: creating an event and an event album with a digital photo-sharing mobile application by: allowing a host to create the event, creating the event album for the event; inviting a set of collaborators to the event; obtaining and uploading a set of digital images as the event album to a digital-image aggregator in a cloud-computing platform, wherein the digital images are provided by the host of the event and the set of collaborators at said event; with the digital-image aggregator in the cloud-computing platform, aggregating the set of digital pictures; sharing the set of digital pictures of the event album between a specified event team that the host has designated, wherein the set of digital pictures are accessible via the cloud-computing platform using a website or a mobile-device application used by authenticated members of the specified event team; and providing a digital photo-sharing mobile application that allows a collaborator to remove unwanted pictures from the event album post events; and enabling the host and the set of collaborators to share the set of digital pictures in the event album via a social media application.

### BRIEF DESCRIPTION OF THE DRAWINGS

FIG. 1 illustrates an example process for implementing an instant digital photo-sharing mobile application, according to some embodiments.

FIG. 2 illustrates another process for implementing an instant digital photo-sharing mobile application using a cloud-computing platform, according to some embodiments.

FIGS. 3-5 illustrate example process for implementing various aspects of a digital photo-sharing platform, according to some embodiments.

FIG. 6 illustrates an example system for implementing a digital photo-sharing platform, according to some embodiments.

FIG. 7 depicts an exemplary computing system that can be configured to perform any one of the processes provided herein.

The Figures described above are a representative set and are not an exhaustive with respect to embodying the invention.

### DESCRIPTION

Disclosed are a system, method, and article of manufacture for implementing a digital photograph sharing mobile application. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” ‘one example,’ or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Cloud computing can involve deploying groups of remote servers and/or software networks that allow centralized or decentralized data storage and elastic online access (meaning when demand is more, more resources will be deployed and vice versa) to computer services or resources. These groups of remote servers and/or software networks can be a collection of remote computing services.

Digital image is an image composed of picture elements, also known as pixels, each with finite, discrete quantities of numeric representation for its intensity or gray level that is an output from its two-dimensional functions fed as input by its spatial coordinates denoted with x, y on the x-axis and y-axis, respectively.

Example Methods

In some examples, present methods provide an instant digital photo-sharing mobile application. Instant digital video-sharing mobile applications can also be provided as well. The collaborative democratizing memories. The instant digital photo-sharing mobile application enables the host of an event to collect the pictures and videos from selected co-hosts (e.g. collaborators). The co-hosts can be selected in real-time during the live event. Additionally, the instant digital photo-sharing mobile application can enable the host to collect and share pictures and videos after the event. The present methods provide enable users to proactively collect the digital pictures for the events they host upfront and in real-time.

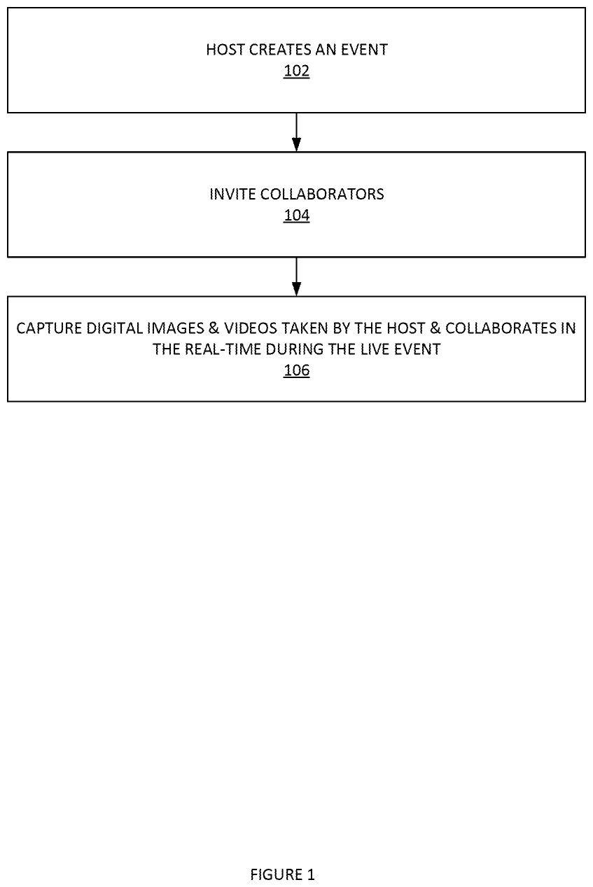

FIG. 1 illustrates an example process 100 for implementing an instant digital photo-sharing mobile application, according to some embodiments. In step 102, process 100 allows a host to create an event. In step 104, process 100 can invite collaborators. In step 106, process 100 can capture digital images and videos taken by the host and collaborates in the real-time during the live event.

Process 100 can be implemented using the digital photo-sharing mobile application. With the digital photo-sharing mobile application, process 100 can enable the user (e.g. event host, host, etc.) to instantly create events, invite the collaborators (family members, friends, colleagues, etc.) to the events and capture the pictures and videos taken by the host and collaborates in the real-time during the live event. Process 100 can be implemented with n-number taps (e.g. two taps, three taps, etc.) to virtual buttons of the digital photo-sharing mobile application.

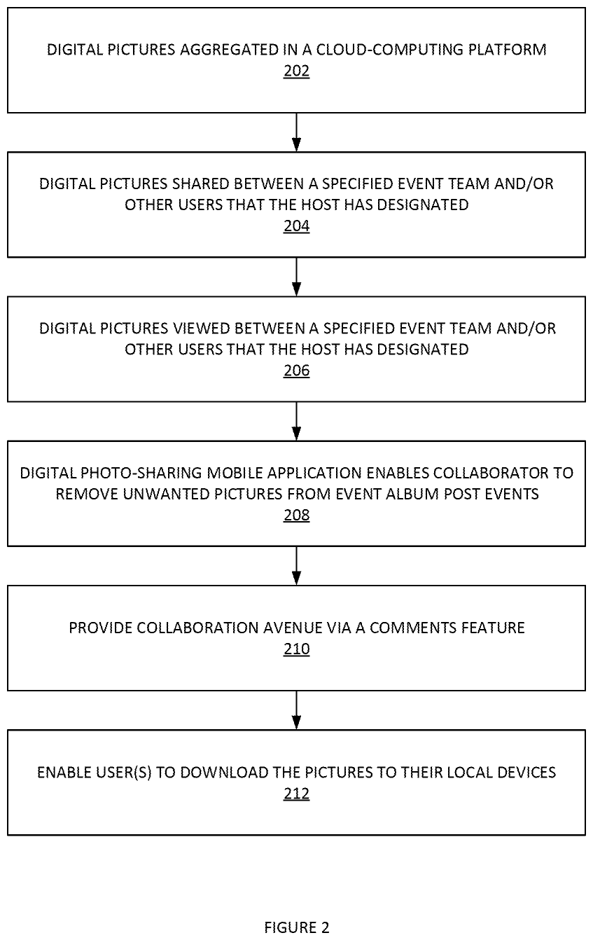

FIG. 2 illustrates another process 200 for implementing an instant digital photo-sharing mobile application using a cloud-computing platform, according to some embodiments. In step 202, the digital pictures (e.g. digital images, digital videos, etc.) can be aggregated in a cloud-computing platform. Via the cloud-computing platform, in step 204, the digital pictures can be shared between a specified event team and/or other users that the host has designated. Via the cloud-computing platform, in step 206, the digital pictures can be viewed between a specified event team and/or other users that the host has designated. In this way, the digital pictures and videos ca be viewable and sharable via a worldwide website/application as well.

The host (e.g. owner) of the digital pictures or videos can have full flexibility to share only the digital pictures the host wants to share. The host can keep specified digital pictures in a non-viewable private state and/or limit viewing privileges to specified users. This can be performed during the live events using a pause and resume functionality provided in the host's digital photo-sharing mobile application.

Additionally, the digital photo-sharing mobile application can allow the collaborator to remove unwanted pictures from the event album post events as well in step 208. In step 210, process 200 can provide collaboration avenue via a comments feature. All the users with access to the event album (e.g. host, collaborators, and other viewers) can be able to engage and socialize using the comments at the event level and at the individual pictures/video level. Users can be able to share all these pictures and videos further using the common platforms like but not limited to email, social media apps (WhatsApp, Facebook, etc.), messenger etc. The user can also be able to download the pictures to their local devices (e.g. mobile devices, etc.) in step 212. In this way, the digital photo-sharing mobile application can provide full flexibility to the user in terms of collecting and sharing digital pictures and digital videos.

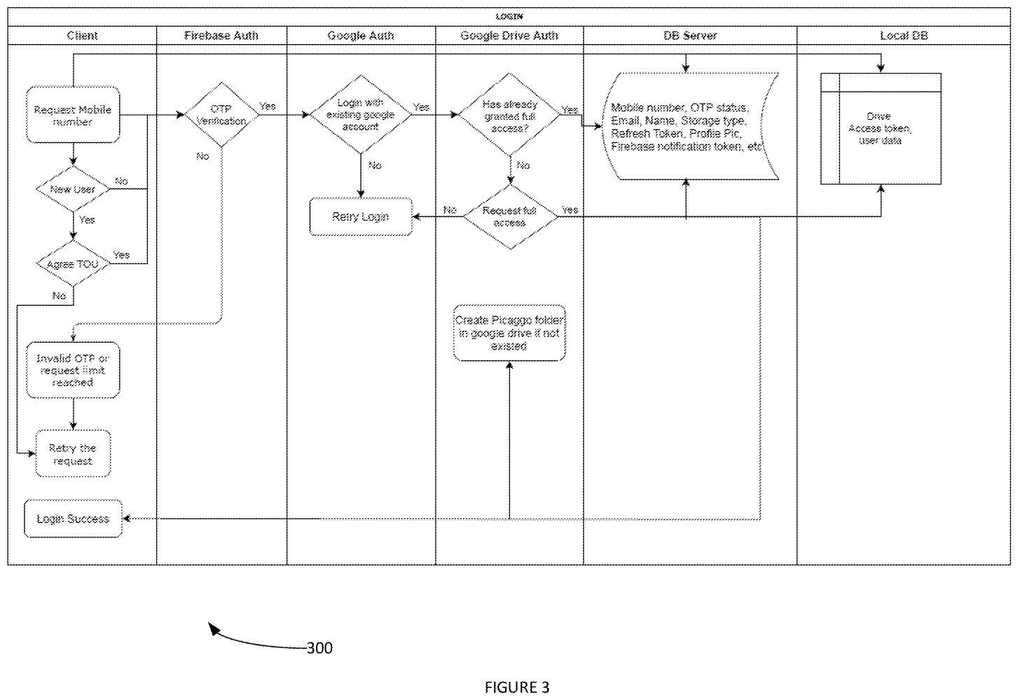

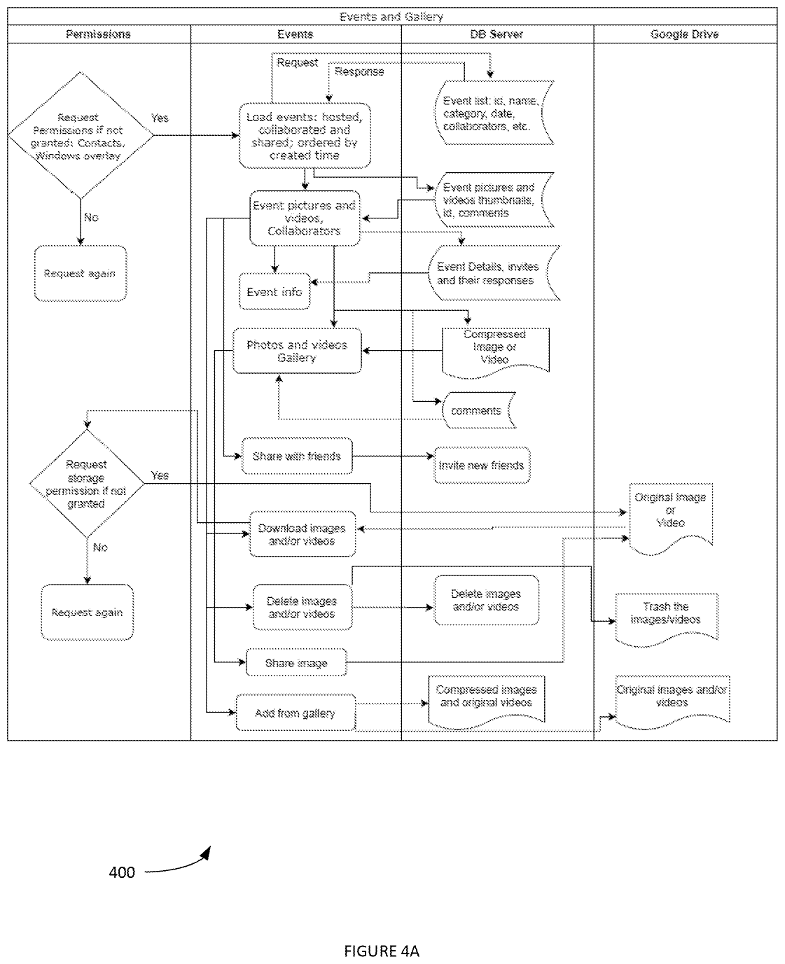

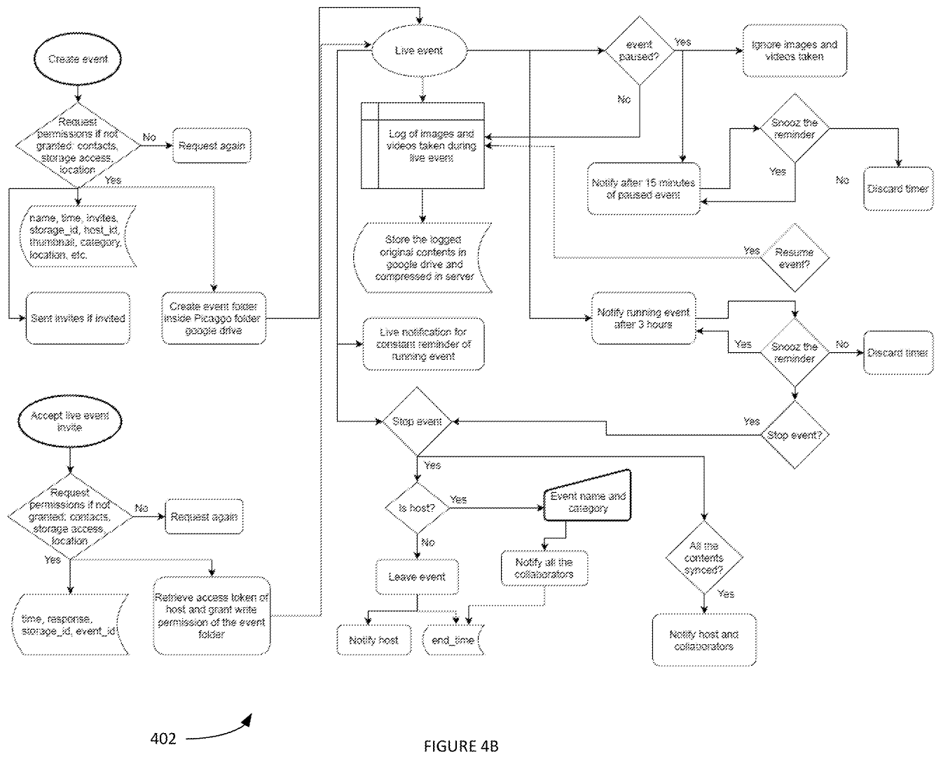

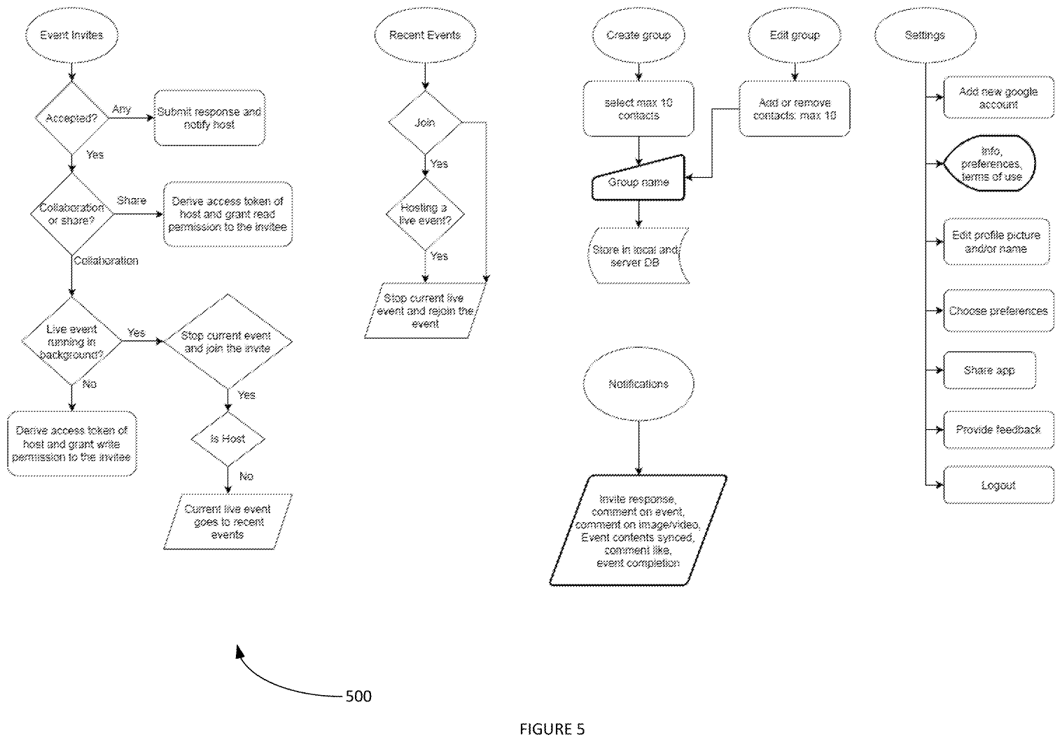

FIGS. 3-5 illustrate example process 300-500 for implementing various aspects of a digital photo-sharing platform, according to some embodiments.

Example Systems

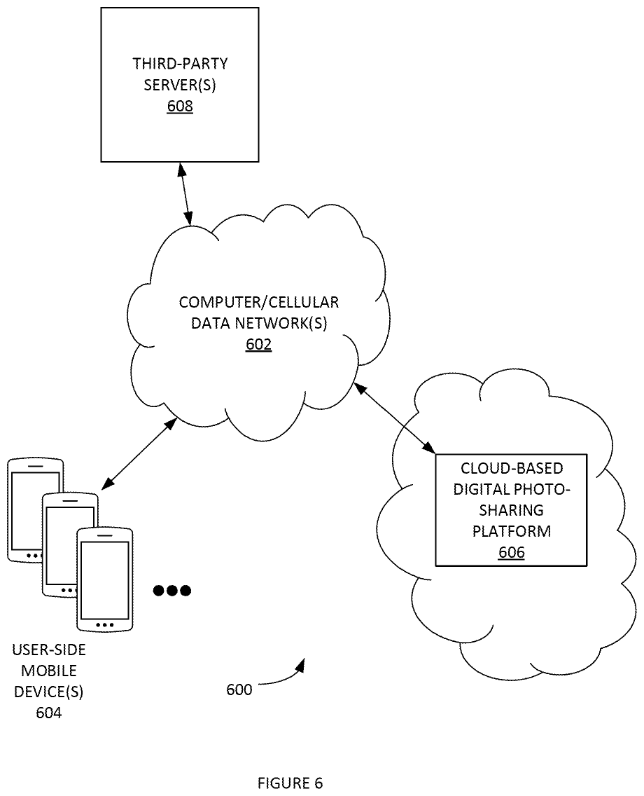

FIG. 6 illustrates an example system 600 for implementing a digital photo-sharing platform, according to some embodiments. System 600 can include various computer and/or cellular data networks 602. Computer and/or cellular data networks 602 can include the Internet, cellular data networks, local area networks, enterprise networks, etc. Networks 602 can be used to communicate messages and/or other information from the various entities of system 600.

System 600 can include user-side mobile devises 604. User-side mobile devices 604 can include digital camera systems. User-side mobile devices 604 can include a digital photo-sharing application. Digital photo-sharing application can implement the user-side steps of processes 100-500.

Processes 100-500 can be combined in various permutations to implement system 600 as well. It is noted that process 100-500 and system 600 can be expanded to operate in an event management platform. The event management platform can provide the scheduling the events in advance and/or in real-time, invite participants and/or capture everything around the event.

Cloud-based digital photo-sharing platform 406 can implement the server-side functions of processes 100-500. Cloud-based digital photo-sharing platform 406 can receive and manage event creations (e.g. from the digital photo-sharing application). Cloud-based digital photo-sharing platform 406 can receive invitations to collaborators and push the invitations to the invited collaborators. Cloud-based digital photo-sharing platform 406 can receive digital images, videos, etc. and associated these with the various access/sharing permissions. Cloud-based digital photo-sharing platform 406 can receive manage events and capture the pictures and videos taken by the host and collaborates in the real-time during the live event.

Cloud-based digital photo-sharing platform 406 can include various functionalities, including, inter alia: web servers, photo-editing tools, data base management systems, online social network systems, etc. Cloud-based digital photo-sharing platform 406 can provide the capability to invite a set of collaborators to the event using QR Code, Link, or in-mobile invite. Cloud-based digital photo-sharing platform 406 can enable the host and the set of collaborators to Sync the collection of digital pictures in the event album to cloud storage, including but not limited to Google® drive, Dropbox®, iCloud®, etc. Cloud-based digital photo-sharing platform 406 can provide that the application is capable of loading compressed as well as original quality Images from all the participants in an event.

The Host can invite other participants as a collaborator or just as a viewer. Additionally, collaborators can participate by sharing their photos/videos whereas viewers are limited to viewing the event photos and videos.

Cloud-based digital photo-sharing platform 406 can implement an ownership transfer. Here, the host can have control over transferring ownership of an event to another person or just inviting other participants as a co-host. Cloud-based digital photo-sharing platform 406 can provide various privacy controls. Users have a choice to only auto-collect Photos and Videos and not auto-upload them. In this case, Users can review and remove photos and Videos they do not want to upload to a shared album.

Cloud-based digital photo-sharing platform 406 can implement facial recognition operations. Here, Users can use their own picture to match and find all their photos in an event album. Cloud-based digital photo-sharing platform 406 can implement various filters. For example, Users can apply various filters to the Photos and Videos in the event album to enhance the photo experience.

Cloud-based digital photo-sharing platform 406 can include an advanced search functionality. The advance search functionality can enable the search pictures and videos by various parameters, including, inter alia: location, facial expression/emotion (e.g. sad, happy, delighted, etc.), brand names, objects, etc.).

Cloud-based digital photo-sharing platform 406 can provide Users the ability to schedule and auto close event. Users can schedule the event in advance and provide the end time. The event would automatically close at the set time. The mobile application won't upload any pictures taken after the event ends. Cloud-based digital photo-sharing platform 406 can provide the ability to invite and RSVP. The mobile application's pre-scheduling capacity would also act as an invitation mechanism for an event, and invitees would choose to RSVP at the event.

Cloud-based digital photo-sharing platform 406 can implement proximity detection. The mobile application can provide a mechanism to detect another application in proximity. This can provide the capability to prompt the user to start an event when he/she is in proximity to another user. This, added with location detection and detecting if one or more users are clicking pictures, can provide the ability to prompt users to start a new event and get to instant photo sharing immediately.

Cloud-based digital photo-sharing platform 406 can include a marketplace. For example, the application can provide a marketplace for vendors to sell their goods digitally. These could be photo frames, printed mugs, printed T-shirts, etc.

Cloud-based digital photo-sharing platform 406 can enable private and/or public events. Users can host private events such as birthday parties, engagements, graduation, marriage, etc., and public events like dance recitals, concerts etc., via the application.

Cloud-based digital photo-sharing platform 406 can enable pic points. Each user would be provided with pic points. These are points provided to users based on their level of participation and would be based on factors such as, inter alia: number of pictures and videos shared, quality of pictures, frequency of sharing the pictures, etc.

Cloud-based digital photo-sharing platform 406 can include editing systems/generative AI system(s) for audio/video creation. Here, one or more video/slideshow(s) can be automatically created for each event. Users can use a video for viewing and sharing with their friends or on social media. Cloud-based digital photo-sharing platform 406 can provide user notifications via SMS, Whatsapp, etc.

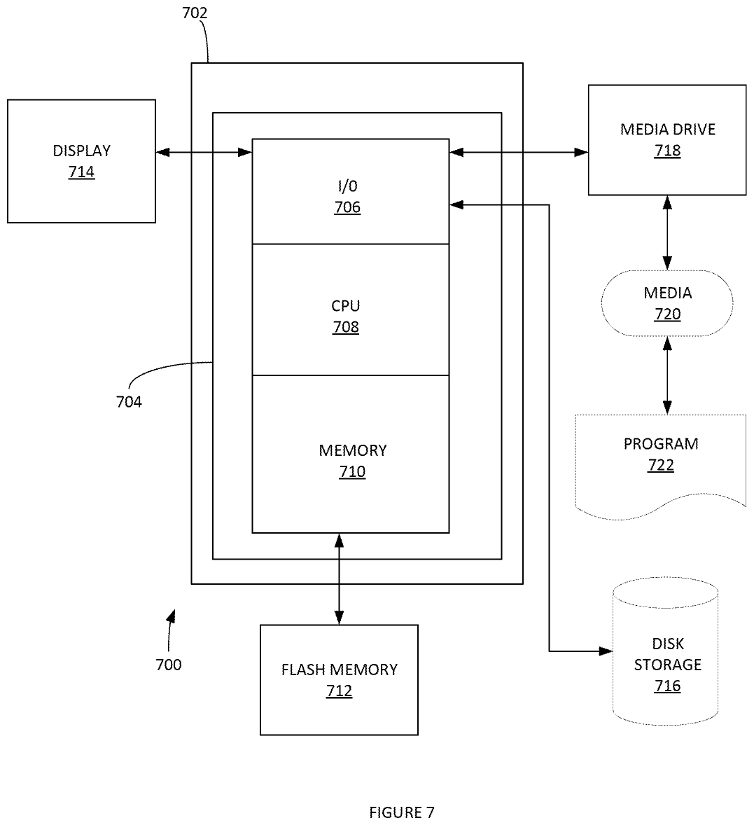

FIG. 7 depicts an exemplary computing system 700 that can be configured to perform any one of the processes provided herein. In this context, computing system 700 may include, for example, a processor, memory, storage, and I/O devices (e.g., monitor, keyboard, disk drive, Internet connection, etc.). However, computing system 700 may include circuitry or other specialized hardware for carrying out some or all aspects of the processes. In some operational settings, computing system 700 may be configured as a system that includes one or more units, each of which is configured to carry out some aspects of the processes either in software, hardware, or some combination thereof.

FIG. 7 depicts computing system 700 with a number of components that may be used to perform any of the processes described herein. The main system 702 includes a motherboard 704 having an I/O section 706, one or more central processing units (CPU) 708, and a memory section 710, which may have a flash memory card 712 related to it. The I/O section 706 can be connected to a display 714, a keyboard and/or other user input (not shown), a disk storage unit 716, and a media drive unit 718. The media drive unit 718 can read/write a computer-readable medium 720, which can contain programs 722 and/or data. Computing system 700 can include a web browser. Moreover, it is noted that computing system 700 can be configured to include additional systems in order to fulfill various functionalities. Computing system 700 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed by United States patent:

1. A computerized method utilizing an instant digital photo-sharing mobile application using a cloud-computing platform comprising:
creating an event and an event album with a digital photo-sharing mobile application by:
allowing a host to create the event,
creating the event album for the event;
inviting a set of collaborators to the event;
obtaining and uploading a set of digital images as the event album to a digital-image aggregator in a cloud-computing platform, wherein the digital images are provided by the host of the event and the set of collaborators at said event;
with the digital-image aggregator in the cloud-computing platform, aggregating the set of digital pictures;
sharing the set of digital pictures of the event album between a specified event team that the host has designated, wherein the set of digital pictures are accessible via the cloud-computing platform using a website or a mobile-device application used by authenticated members of the specified event team; and
providing a digital photo-sharing mobile application that allows a collaborator to remove unwanted pictures from the event album post events; and
enabling the host and the set of collaborators to share the set of digital pictures in the event album via a social media application.

2. The computerized method of claim 1, wherein the digital image comprises a digital video.

3. The computerized method of claim 2, wherein the digital images are viewable and sharable via a worldwide by any users designated with access by the host.

4. The computerized method of claim 3, wherein the host of the digital images has full flexibility to share only the digital pictures to be shared.

5. The computerized method of claim 4, wherein the host is enabled to keep specified digital pictures in a non-viewable private state.

6. The computerized method of claim 5, wherein the host is enabled to keep specified digital pictures in a limit viewing state with only host specified privileges provided to a set of specified users designated by the host.

7. The computerized method of claim 6, wherein the host is enabled to set the non-viewable private state of a digital image during a live events using a pause and resume functionality provided in the host's digital photo-sharing mobile application.

8. The computerized method of claim 7 further comprising:
providing a comments feature for each digital image of the set of digital images.

9. The computerized method of claim 8, wherein the host and all the collaborators with access to the event album socialize using the comments feature at an event level and at an individual digital image level.

10. The computerized method of claim 9 further comprising:
providing an application programming interface that enables the digital-image aggregator to share the set of digital images to a third-party online social networking website.

11. A computerized system utilizing an instant digital photo-sharing mobile application using a cloud-computing platform comprising:
at least one processor configured to execute instructions;
a memory containing instructions when executed on the processor, causes the at least one processor to perform operations that:
create an event and an event album with a digital photo-sharing mobile application by:
allow a host to create the event,
create the event album for the event;
invite a set of collaborators to the event;
obtain and upload a set of digital images as the event album to a digital-image aggregator in a cloud-computing platform, wherein the digital images are provided by the host of the event and the set of collaborators at said event;
with the digital-image aggregator in the cloud-computing platform, aggregate the set of digital pictures;
share the set of digital pictures of the event album between a specified event team that the host has designated, wherein the set of digital pictures are accessible via the cloud-computing platform using a website or a mobile-device application used by authenticated members of the specified event team;
provide a digital photo-sharing mobile application that allows a collaborator to remove unwanted pictures from the event album post events; and
enable the host and the set of collaborators to share the set of digital pictures in the event album via a social media application.

12. The computerized system of claim 11, wherein the digital image comprises a digital video.

13. The computerized system of claim 12, wherein the digital images are viewable and sharable via a worldwide by any users designated with access by the host.

14. The computerized system of claim 13, wherein the host of the digital images has full flexibility to share only the digital pictures to be shared.

15. The computerized system of claim 14, wherein the host is enabled to keep specified digital pictures in a non-viewable private state.

16. The computerized system of claim 15, wherein the host is enabled to keep specified digital pictures in a limit viewing state with only host specified privileges provided to a set of specified users designated by the host.

17. The computerized system of claim 16, wherein the host is enabled to set the non-viewable private state of a digital image during a live events using a pause and resume functionality provided in the host's digital photo-sharing mobile application.

18. The computerized system of claim 17, wherein a comments feature is provided for each digital image of the set of digital images.

19. The computerized system of claim 18, wherein the host and all the collaborators with access to the event album socialize using the comments feature at the event level and at the individual digital image level.
